(19) United States
(12) Patent Application Publication
(10) Pub. No.: US 2009/0179341 A1
(43) Pub. Date: Jul. 16, 2009

(54) SONICATION METHODS FOR SCREENING AND PREPARING SOLID FORMS

(76) Inventor: Linda McCausland, Oxfordshire (GB)

Correspondence Address: MCANDREWS HELD & MALLOY, LTD, 500 WEST MADISON STREET, SUITE 3400, CHICAGO, IL, 60661, US

(21) Appl. No.: 12/158,636

(22) PCT Filed: Dec. 20, 2006
(86) PCT No.: PCT/US06/48620

§ 371 Date: Jun. 20, 2008

Related U.S. Application Data
(60) Provisional application No. 60/752,837, filed on Dec. 21, 2005.

(51) Int. Cl. B29B 9/00; G01J 3/44; G01V 3/00; G01J 5/02; G01N 23/20

(52) U.S. Cl. 264/9; 356/301; 324/307; 250/339.07; 378/70

(57) ABSTRACT

Methods for screening and preparing solid forms are described herein. Such methods comprise sonicating a solid paste to provide a sonicated paste. The sonicated paste may be analyzed for the presence of solid forms.

### CROSS-REFERENCE TO RELATED APPLICATION

This application claims priority of U.S. Provisional Application No. 60/752,837 filed Dec. 21, 2005.

### DETAILED DESCRIPTION OF THE INVENTION

Solid forms are chemical compounds or elements in the solid-state. As used herein, solid forms include, but are not limited to, polymorphs, allotropes, solvates, hydrates, amorphous compounds, mesophases, liquid crystals, salts, and cocrystals. Polymorphs are chemical compounds having the same chemical structure but which differ in their crystal structure. Crystal structure refers to an array of repeating segments in the solid state. The smallest repeating segment in a crystal is called a unit cell. Because polymorphs of the same compound have different unit cells, they have different solid-state structures. For example, it is well known that succinylsulfathiazole crystallizes into six polymorphs with differing properties giving rise to different differential scanning calorimetry (DSC) traces, infrared (IR) spectra, x-ray powder diffraction (XRPD) patterns, vapor absorption behavior, dissolution rates, and solubilities. (S. Byrn et al. Solid-state Chemistry of Drugs p. 166 (1999)).

Allotropes are polymorphs that are elements. As used herein solid forms include both allotropes and elements that do not exhibit allotropism.

In a solvate, the crystal structure also contains a solvent molecule and in a hydrate that molecule is water. Solvates and hydrates also include crystals where the solvent or water molecules are in channels. Solvents within a solvate can include any solvent used in organic synthetic techniques. Such solvents include, but are not limited to, dichloromethane, chloroform, methanol, ethanol, isopropyl alcohol, acetonitrile, acetone, dimethylsulfoxide, benzene, toluene, tetrahydrofuran, hexafluoroisopropyl alcohol, ethyl acetate, nitromethane, and dimethylformamide. Solvates include hemisolvates, monosolvates, sesquisolvates, and other levels of solvation, and solvates with different levels of solvation may have different solid-state properties. Hydrates include hemihydrates, monohydrates, sesquihydrates and other levels of hydration, and hydrates with different levels of hydration may have different solid-state properties.

Amorphous compounds are also classified as solid forms, although they are not crystalline solid forms. Other solid forms include mesophases and liquid crystals.

Crystalline solid forms also include salts. The term “salts”, as used herein, means compounds that are neutral ionic compounds comprising an anion and a cation. In many pharmaceutical salts, the cation is a pharmacologically active species where the anion is a counterion used to make a salt. Pharmacologically acceptable salts include acetate, alginate, ascorbate, aspartate, benzoate, besylate, bezoate, bicarbonate, bisulphate, bitartrate, borate, bromide, camsylate, carbonate, chloride, citrate, cypionate, decanoate, dichloroacetate, dihydrochloride, edetate, edisylate, embonate (pamoate), estrolate, fumarate, fuisidate, gallate, gluconate, glucuronate, glutamate, hemisuccinate, hexanoate, hippurate, hydrobromide, hydrochloride, hydroxybenzoate, isethionate, lactate, lactobionate, laurate, malate, maleate, malonate, mandelate, mesylate, mononitrate, monosulphate, mucate (galactarate), napadisylate, napsylate, nicotinate, nitrate, oleate, oxalate, palmitate, phenylpropionate, phosphate, pivalate, propionate, salicylate, stearate, succinate, sulfosalicylate, sulphate, tartrate, terephthalate, tosylate, undecanoate, and valerate.

In many other pharmaceuticals, the anion may be a pharmacologically active species whereas the cation is a counterion used to make a pharmaceutical salt. In these pharmaceuticals, pharmaceutically acceptable salts include those made using diethanolamine, ethylene diamine, piperazine, n-methyl-d-glucamine, ethanolamine, tromethamine, triethanolamine, diethylamine, diethylaminoethanol, n-(2-hydroxyethyl)morpholine, betaine, n-(2-hydroxyethyl)pyrrolidine, 1-h imidazole, deanol, choline, 1-lysine, (I)-arginine, benethamine, benzathine, dl-lysine, ammonium hydroxide, calcium hydroxide, magnesium hydroxide, sodium hydroxide, potassium hydroxide, zinc hydroxide, and hydrabamine.

Cocrystals are crystals that contain two or more non-identical molecules. Examples of cocrystals may be found in the Cambridge Structural Database. Examples of cocrystals may also be found at Etter, Margaret C., and Daniel A. Adsmond (1990) “The use of cocrystallization as a method of studying hydrogen bond preferences of 2-aminopyridine” J. Chem. Soc., Chem. Commun. 1990 589-591; Etter, Margaret C., John C. MacDonald, and Joel Bernstein (1990a) “Graph-set analysis of hydrogen-bond patterns in organic crystals” Acta Crystallogr., Sect. B, Struct. Sci. B46 256-262; Etter, Margaret C., Zofia Urbańczyk-Lipkowska, Mohammad Zia-Ebrahimi, and Thomas W. Panunto (1990b) “Hydrogen bond directed cocrystallization and molecular recognition properties of diarylureas” J. Am. Chem. Soc. 112 8415-8426, which are incorporated herein by reference in their entireties. The following articles are also incorporated herein by reference in their entireties: Carl Henrik Görbotz and Hans-Petter Hersleth, 2000, “On the inclusion of solvent molecules in the crystal structures of organic compounds” Acta Cryst. (2000), B56, 625-534; and V. S. Senthil Kumar, Ashwini Nangia, Amy K. Katz and H. L. Carrell, 2002, “Molecular Complexes of Some Mono- and Dicarboxylic Acids with trans-1,4,-Dithiane-1,4-dioxide” American Chemical Society, Crystal Growth & Design, Vol. 2, No. 4, 2002.

By cocrystallizing an active agent with a guest, one creates a new solid form which has unique properties compared with existing solid forms containing, or of, that active agent. Such properties include melting point, density, hygroscopicity, crystal morphology, loading volume, compressibility, and shelf life. Furthermore, other properties such as bioavailability, toxicity, taste, physical stability, chemical stability, production costs, and manufacturing method may be modified by using a cocrystal rather than an API solid-form alone, or as a salt.

An active agent is a molecule that has a desired activity. In the pharmaceutical field, the active agent is often an active pharmaceutical ingredient (“API”), and the other component of the cocrystal (the guest) is often a pharmaceutically acceptable compound (which could also be an API). Cocrystals containing APIs can be used to deliver APIs therapeutically. New drug formulations comprising cocrystals of APIs with pharmaceutically acceptable guests may have superior properties over existing drug formulations. Active agents and guests may also include nutraceuticals, agricultural chemicals, pigments, dyes, explosives, polymer additives, lubricant additives, photographic chemicals, and structural and electronic materials.

An active agent, such as an API, can be screened for possible cocrystals where polymorphic forms, hydrates, or solvates do not readily form. For example, a neutral compound that can only be isolated as amorphous material could be cocrystallized. Forming a cocrystal may upgrade the performance of a drug formulation of an API by, for example, changing one or more physical properties identified earlier. A cocrystal may also be used to isolate or purify a compound during manufacturing.

Examples of APIs (or salts thereof) may be found, for instance, in the FDA Orange Book. Such APIs include, but are not limited to, cardiovascular pharmaceuticals; anti-infective components; psychotherapeutic components; gastrointestinal products; respiratory therapies; cholesterol reducers; cancer and cancer-related therapies; blood modifiers; antiarthritic components; AIDS and AIDS-related pharmaceuticals; diabetes and diabetes-related therapies; biologicals; hormones; analgesics; dermatological products; anesthetics; migraine therapies; sedatives and hypnotics; imaging components; and diagnostic and contrast components.

The active agent may be provided as a salt. One or more salts may be employed in a cocrystal. The salt may be prepared from the active agent or obtained from a commercial source. In the pharmaceutical industry, for instance, hydrochloride salts of active pharmaceutical ingredients, especially of amine APIs, are commonly used. Examples of salts include, but are not limited to, those formed from the acids in table 1:

TABLE 1

sulfuric acid
phosphoric acid
hydrobromic acid
nitric acid
pyrophosphoric acid
methanesulfonic acid
thiocyanic acid
naphthalene-2-sulfonic acid
1,5-naphthalenedisulfonic acid
cyclamic acid
p-toluenesulfonic acid
maleic acid
L-aspartic acid
2-hydroxy-ethanesulfonic acid
glycerophosphoric acid
ethanesulfonic acid
hydroiodic acid

When the active agent, such as an API, is a hydrochloride (HCl) salt, one can cocrystallize the HCl salt with a neutral guest molecule. This creates a cocrystal with specific properties. For instance one can make a cocrystal comprising an active pharmaceutical ingredient having greater or lesser intrinsic solubility and/or a faster or slower dissolution rate, depending on the guest compound that is chosen.

By “guest” what is meant is the component of the cocrystal that is not the primary active agent of the cocrystal. The guest is primarily present in order to form the cocrystal with the active agent. It is contemplated that one or more guests may be employed in a cocrystal according to any of the techniques of the disclosure. Accordingly, the guest is not required to have an activity of its own, although it may have some activity. In some situations, the guest may have the same activity as or an activity complementary to that of the active agent. The guest may be another active agent. For example, some guests may facilitate the therapeutic effect of an active pharmaceutical ingredient. For pharmaceutical formulations, the guest may be any pharmaceutically acceptable molecule that forms a cocrystal with the API or its salt. The Registry of Toxic Effects of Chemical Substances (RTECS) database is a useful source for toxicology information, and the Generally Recognized as Safe (GRAS) list contains about 2500 relevant compounds. Both sources may be used to help identify guests.

The guest may be neutral, such as benzoic acid and succinic acid, or ionic, such as sodium benzoate or sodium succinate. Neutral guests are non-ionized guests. Ionic guests are compounds or complexes having ionic bonds. General classes of guests include but are not limited to organic bases, organic salts, alcohols, aldehydes, amino acids, sugars, ionic inorganics, aliphatic esters, aliphatic ketones, organic acids, aromatic esters, and aromatic ketones.

Typically, guests will have the ability to form complementary non-covalent interactions with the active agent or its salt, including APIs and salts thereof, such as, for example, the ability to form hydrogen bonds with the active agent or its salt. Guests for active agents, such as APIs, having negative counterions include compounds having alcohol, ketone, ester, and/or carboxylic acid functionalities. Guests may include organic acids, organic bases, organic salts, alcohols, aldehydes, amino acids, sugars, ionic inorganic compounds, aliphatic esters and ketones, and aromatic esters and ketones. Specific examples of guests are found in table 2.

TABLE 2

L-(+)-tartaric acid
citric acid
benzoic acid
fumaric acid
adipic acid
succinic acid
L-malic acid
4-hydroxybenzoic acid
glutaric acid
DL-malic acid
malonic acid
salicylic acid
glycolic acid
1-hydroxy-2-naphthoic acid
gentisic acid
DL-tartaric acid
maleic acid
oxalic acid
gallic acid
hippuric acid
(+)-camphoric acid
pyroglutamic acid
ketoglutaric acid.

One method of obtaining solid forms, such as cocrystals, is by using solution-state techniques whereby multiple samples of a chemical compound, compounds, element or elements are solidified from solution under a variety of different solidification conditions. By varying one or more of temperature, solvent or anti-solvent content, seeds, concentration, agitation, purity, and other factors, one may create the conditions necessary to solidify solid forms. For example, one typical way to vary conditions is to solidify multiple samples of the same chemical compound in separate containers with different solvents or solvent combinations in each container. In some circumstances, the pH of the solutions containing the chemical compounds may be varied. In another example, one may also vary the rate at which the solvents in the container evaporate by, for instance, varying the heating temperature and heating rate among different containers or covering the containers to slow evaporation. Further, one may combine solutions containing the chemical compounds with anti-solvents, which are liquids in which the chemical compounds have poor solubility, to promote solidification.

Another method for preparing solid forms, such as cocrystals, is by solid-state techniques such as grinding or milling. In some cases, particular solid forms have been shown to form by grinding or milling but have not successfully been prepared by solvent evaporation technique. Trask, A. V. et al., Cryst. Growth and Design; 2005; 5(6); 2233-2241. Solid-state techniques such as grinding or milling are, however, labor intensive and are often difficult to perform in small vessels such as the wells of microliter well plates. For example, it has been observed that solid forms of nabumetone prepared in capillaries with solvent-evaporation techniques were not able to be reproduced in well plates using solution-state methods or solid-state methods such as grinding or milling. L. Chyall et el., Crystal Growth & Design 2002, 12, 505-510. Such solid forms can be prepared, however, as per the instant disclosure as shown in example 4. It would be advantageous to have a method whereby one could, for example, prepare solid forms such as cocrystals in the solid-state without the use of grinding or milling.

Screening for solid forms is a method by which an analysis is taken of solids to determine whether new solid forms have formed in an experiment or series of experiments. Screening is partially a function of time and effort, with the quality or results of screening being related to the number of samples prepared and/or analyzed as well as the quality of preparation and/or analysis underlying those samples. Persons working in the pharmaceutical arts will recognize that screens are often performed for purposes other than to identify new solid forms. For example, screens are often performed to look for new APIs with particular activities. In many such screening processes, including screening for new solid forms, variations are introduced in order to see the results, if any, of such variations, or to confirm that variations do not lead to substantially different results. Once screening conditions have been identified which result in specific cocrystals, those conditions can then be reproduced to prepare those cocrystals. For example, if it is determined that the combination of an active agent and guest at a particular concentration and pH results in a cocrystal upon evaporation in the well of a well plate, then those conditions can be reproduced in another well plate or other container in order to prepare that cocrystal again. Similarly, screens using solid-state techniques can be reproduced to prepare cocrystals that formed during a screen using solid-state techniques.

In order to identify the presence of and characterize a solid form, one uses analytical techniques. Persons working in the pharmaceutical arts use analytical techniques to characterize crystals, including solid forms such as cocrystals. For example, the chemical identity of the components of cocrystals can often be determined with solution-state techniques such as ¹³C or ¹H NMR. While it may help identify the active agent, such as an API, and the guest, such solution-state techniques, however, do not provide information about the cocrystal solid-state structure.

By analyzing a solid form, such as a cocrystal, with a solid-state analytical technique, one can determine whether the solid form is of a new form or a known form. When analyzing a solid form with a solid-state analytical technique, one records data with that technique and compares that data to data collected using the same technique on known solid forms. Typical solid-state analytical techniques for such analyses include x-ray powder diffraction; infrared spectroscopy; solid-state nuclear magnetic resonance spectroscopy; and Raman spectroscopy. Thermal data such as from DSC, melting point, and thermal gravimetric analysis may also provide additional data about solid forms. When analyzing an API sample from a polymorph screen using x-ray powder diffraction, one compares the diffractogram collected on the sample with diffractograms on known solid forms of or containing the API. If the diffractogram on the sample meaningfully differs from the diffractograms of the known solid forms, then the sample represents a new solid form.

In a cocrystal screen using x-ray powder diffraction as a solid-state analytical technique, one compares the diffractogram of a sample resulting from the screen with the diffractograms of the known solid forms of the starting materials. If the diffractograms of the sample meaningfully differ from the diffractogams of the known solid forms, or combinations thereof, of the starting materials, then the sample is indeed a different solid form than any of the starting materials.

Meaningful differences in, for example, x-ray powder diffraction, are readily determined by those working in the pharmaceutical arts by taking factors such as peak position, intensity, and shape when making such comparisons amongst diffractograms. Peak position on the x-axis is typically considered the primary factor in making analytical determinations about solid forms with x-ray powder diffraction data. The data from such an analysis can then be used to characterize the form in that the data can be used to identify the presence of the solid form. In x-ray powder diffraction, for instance, an x-ray source directs x-rays onto a sample where the x-rays are diffracted by the electrons associated with the atoms in the sample. The diffracted x-rays are collected by a detector and provide a pattern that may be used as a fingerprint for a crystalline solid. Thus, crystals of the same structure provide the same x-ray powder diffraction pattern.

An x-ray powder diffraction plot is an x-y graph with °2θ (diffraction) on the x-axis and intensity on the y-axis. The peaks within this plot may be used to characterize a solid form such as a cocrystal. Although the peaks within an entire diffractogram may be used to characterize a cocrystal, one may rely on a subset of that data to characterize a cocrystal. The data is often represented by the position of the peaks on the x-axis rather than the intensity of peaks on the y-axis because peak intensity may vary with sample orientation.

### BRIEF DESCRIPTION OF THE DRAWINGS

FIG. 1 shows the XRPD patterns for selected polymorphs of carbamazepine, succinic acid, and the resulting cocrystal.

FIG. 2 shows the XRPD patterns for selected polymorphs of carbamazepine, oxalic acid, and the resulting cocrystal.

FIG. 3 shows the XRPD patterns for carbamazepine/succinic acid cocrystal obtained from the microplate and grinding experiments.

FIG. 4 shows the XRPD pattern for Nabumetone form C and Nabumetone/glycolic acid microplate experiment.

FIG. 5 shows XRPD patterns for Nabumetone polymorphs A and C obtained from the sonicated microplate.

FIG. 6 shows the XRPD patterns for fluoxetine HCl, benzoic acid and the resulting cocrystal.

In one aspect of the present disclosure, a method for screening solid forms is disclosed wherein one or more solids are combined together with a suitable liquid to form a solid paste. The solid paste is then subject to sonication to screen for the formation of a solid form. An analysis is performed on the resulting sonicated paste to determine whether the sonicated paste contains a solid form.

In another aspect of the disclosure, a solid form is prepared by sonicating a solid paste comprising one or more solids followed by analysis for the presence of a solid form in the resulting sonicated paste.

By “solid paste” what is meant is a solid, moveable phase made by combining one or more solids, and sufficient suitable liquid to mobilize the resulting mixture. The solids used may include active agents such as APIs. When screening for or preparing cocrystals, the solids employed will include active agents such as APIs and, if the guest is a solid, at least one guest.

By “suitable liquid” what is meant is a liquid capable of forming a solid paste. Examples of suitable liquids include organic solvents. Suitable liquids further include acetone, acetonitrile, dichloromethane, diethyl ether, diisopropyl ether, dioxane, dimethylformamide, dimethyl sulfoxide, ethanol, ethyl acetate, heptane, hexanes, propan-2-ol, methanol, tetrahydrofuran, toluene, and water.

By “sufficient” what is meant is the application of liquid to create a medium by which the solid particles within the solid are in contact for sonication.

The term “sonicated paste” refers to the solid paste after sonication.

The terms “sonication” and “sonicate” refer to the application of sound including ultrasound. A solid paste may be sonicated in a variety of ways, such as continuously or by one or more pulses. Often one pulse of sonic energy including ultrasound sound is used which is generally on the order of 1 second or less, about 1 to 5 seconds, about 5-10 seconds, or about 10 seconds or more. When a solid paste is sonicated “while” or “during” some other step or time period, it means at least one pulse is applied—it does not necessarily mean there is sonication over the entire step or period, although in some circumstances, it can be desirable to sonicate periodically or continuously throughout substantially an entire step or over substantially all of a time period, or for some portion of the step or period.

Sonication can be applied to a sample by conventional techniques such as by immersing a receptacle containing the sample in an ultrasonic bath, or by placing the tip of an ultrasonic probe directly into the sample. Sonication of a sample may be performed using commercially available equipment. For example, a quarter-inch diameter (6 mm) ultrasonic probe operating at 20 kHz and a power input of 130 watts has been found convenient. One commercial device used to sonicate samples is SonicMan™ which operates at 20 kHz with variable power to a maximum of 1,150 Watts. SonicMan™ is supplied by MatriCal Inc. of Spokane, Wash. Lower power ultrasound devices may also be suitable for crystallization. Suitable ultrasound devices are advertised by Cole-Palmer Instrument Co., of Vernon Hills, Ill., or Misonix Corporation, of Farmingdale, N.Y. For scaled-up operations, a sonoreactor is advertised by AEA Technologies of the United Kingdom. Techniques and equipment include the use of ultrasonic probes or transducers, which techniques will be familiar to those working in the art.

Ultrasound generally refers to sound vibrations beyond the limit of audible frequencies. Ultrasound is often used to refer to sound vibrations having a frequency of about 20 kHz or more. In many applications where ultrasound is used, the frequencies are in the range of 20 kHz to 5 MHz. However, the definition of ultrasound as having a frequency greater than 20 kHz is related to the average perception limit of the human ear rather than to industrial applications. The benefits of the present disclosure may be obtained with frequencies below 20 kHz such as between about 15 KHz and about 20 Khz and up to about 130 Khz. In the context of the present disclosure, ultrasound refers to sound vibrations having a frequency in the range of from about 20 kHz to about 130 KHz. This includes a range of between about 20 KHz and about 40 KHz.

In one embodiment of the disclosure, the solid forms that are screened for are cocrystals. In this embodiment, one or more active agents are combined with one or more guests in the solid state. A sufficient amount of a suitable liquid is added to form a solid paste and the resulting solid paste is sonicated to provide a sonicated paste. The suitable liquid of the solid paste provides for a medium by which sonic energy may be transmitted throughout the entire solid paste. By virtue of being a solid paste, the solid particles of active agent and guest have more efficient contact for the transmission of sonic energy than if they were simply physically mixed together. After sonication, an analysis is performed on the sonicated paste, such as by using x-ray powder diffraction, to determine whether a cocrystal has formed in the sonicated paste. By comparing the x-ray powder diffraction patterns of the active agent and the guest alone and in combination, one of skill in the pharmaceutical arts may determine whether a cocrystal has formed.

In another embodiment of the disclosure, a cocrystal screen is performed where one or more active agents and one or more guests are combined in a container such as the well of a well plate and a sufficient amount of a suitable liquid to form a solid paste is added to the well of the well plate. In such a screen utilizing a well plate, such as a 96-well microplate, each well of the well plate may contain a different set of active agent/guest combinations. Examples of well plates include commercial and non-commercial microplates containing 6, 24, 96, 384, 1536, or 6144 wells. The standards for commercially available microplates are SBS/ANSI 1-2004 (specifying footprint dimensions), SBS/ANSI 2-2004 (specifying height dimensions), SBS/ANSI 3-2004 (specifying Bottom Outside Flange Dimensions), or SBS/ANSI 4-2004 (specifying well positions for 96, 384, 1536 well plates only). Microplate bottoms are often polymers such as polypropylene or polycarbonate. The wells of the well plate are then sonicated at a frequency such as between approximately 15 kHz and approximate 130 kHz including between approximately 20 kHz and approximately 130 kHz for a time period of 2 seconds to several minutes. In some cases it is useful to sonicate again after a silent period of a few seconds to several minutes.

In addition to well plates, examples of containers for sonication of solid forms, including cocrystals screens, include test tubes, capillaries, vials and microscope slides. Sonication may also be performed on larger scale containers. Such containers may be used, for example, to prepare a solid form such as a cocrystal in larger amounts than would be made in a wellplate and may be based on conditions identified in a screen.

After the sonication, the contents of the well plate are examined by a technique such as x-ray powder diffraction. If the x-ray powder diffraction pattern of the contents of any of the wells of the well plate meaningfully differ from the x-ray powder diffractions of the active agents and guests alone or in combination, then the sonication has created a new solid form. If that solid-form is crystalline, then the sonication has created a cocrystal.

In another embodiment of the disclosure, a polymorph is screened by sonicating a solid paste and analyzing the resulting sonicated paste.

In other embodiments of the disclosure, the solid form selected from allotropes, solvates, hydrates, amorphous compounds, mesophases, liquid crystals, and salts is screened by sonicating a solid paste and analyzing the resulting sonicated paste.

In another embodiment of the disclosure, a cocrystal is prepared by sonicating a solid paste comprising a suitable liquid, one or more active agents, and one or more guests.

In a further embodiment of the disclosure, a polymorph is prepared by sonicating a solid paste.

In another embodiment of the disclosure, the solid form selected from allotropes, solvates, hydrates, amorphous compounds, mesophases, liquid crystals, and salts is prepared by sonicating a solid paste.

In an additional embodiment of the disclosure, a salt is screened for by sonicating a solid paste and analyzing the resulting sonicated paste.

In a further embodiment of the disclosure, a salt is prepared by sonicating a solid paste.

In yet a further embodiment of the disclosure, an API is screened for forming cocrystals wherein the API has insufficient solubility to afford an effective screen from solution-state techniques.

Examples of further embodiments of the disclosure described herein are indicated below without, however, being limiting in nature.

### EXAMPLES

### Example 1

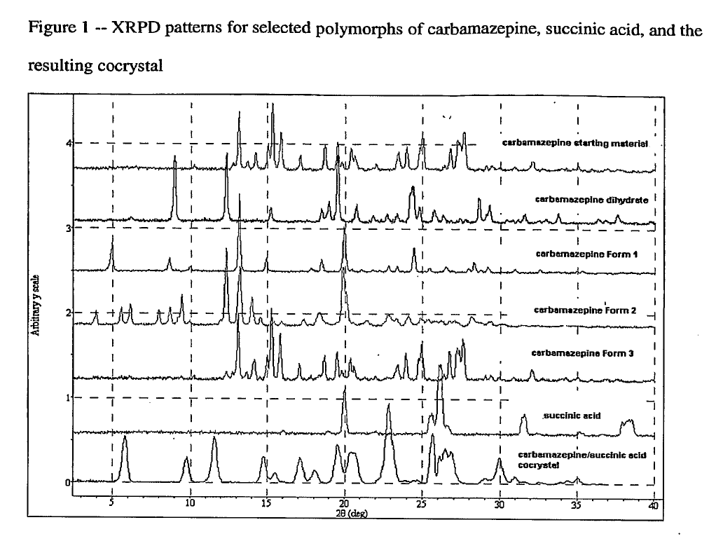

Approximately 3 mg of carbamazepine and 1 mg of succinic acid together with 100 microlitres of acetone were combined to form a solid paste and were placed in three wells of a 96-well microplate. The remaining wells each contained either 3 mg of carbamazepine together with an acid other than succinic acid or were used as controls. The 96-well microplate was placed in a SonicMan™ (MatriCal Inc., Spokane, Wash.) sonication device where the microplate was sealed with an interchangeable disposable sonic lid containing 96 individual sonic pins, one for each well of the well plate. Each pin was in contact with the sample in the respective well. The SonicMan™ device was then used to deliver sonic energy to the sample. The microplate was subjected to 2 seconds of ultrasound at 20 kHz. After a pause of 20 seconds, the microplate was again subjected to 2 seconds of ultrasound at 20 kHz. This cycle was repeated until ten two-second bursts of 20 kHz ultrasound had been delivered to the microplate. Solvent remaining in the microplate was allowed to evaporate at room temperature. FIG. 1 shows the XRPD patterns for carbamazepine, succinic acid, and the resulting cocrystal.

### Example 2

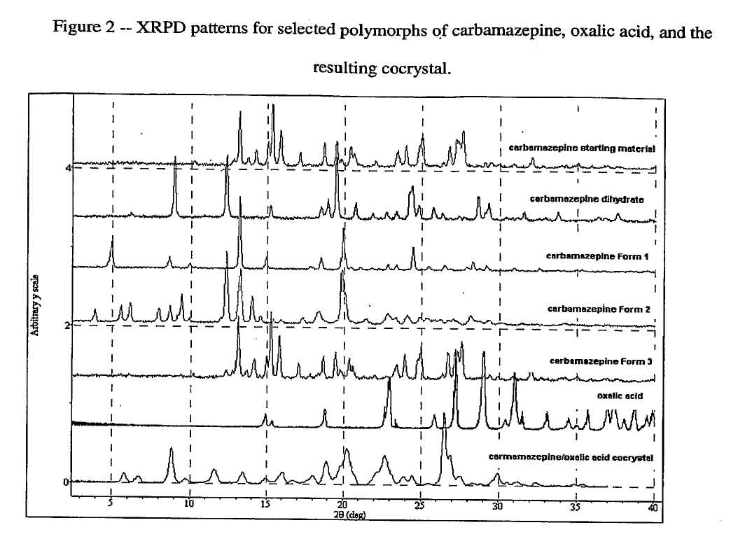

Approximately 3 mg of carbamazepine and 1 mg of oxalic acid together with 100 microlitres of acetone were combined to form a solid paste placed in three wells of a 96-well microplate. The remaining wells each contained either 3 mg of carbamazepine together with an acid other than oxalic acid or were used as controls. The 96-well microplate was placed in a SonicMan™ (MatriCal Inc., Spokane, Wash.) sonication device where the microplate was sealed with an interchangeable disposable sonic lid containing 96 individual sonic pins, one for each well of the well plate. Each pin was in contact with the sample in the respective well. The SonicMan™ device was then used to deliver sonic energy to the sample. The microplate was subjected to 2 seconds of ultrasound at 20 kHz. After a pause of 20 seconds, the microplate was again subjected to 2 seconds of ultrasound at 20 kHz. This cycle was repeated until ten two-second bursts of 20 kHz ultrasound had been delivered to the microplate. Solvent remaining in the microplate was allowed to evaporate at room temperature. FIG. 2 shows the XRPD patterns for carbamazepine, oxalic acid, and the resulting cocrystal.

### Example 3

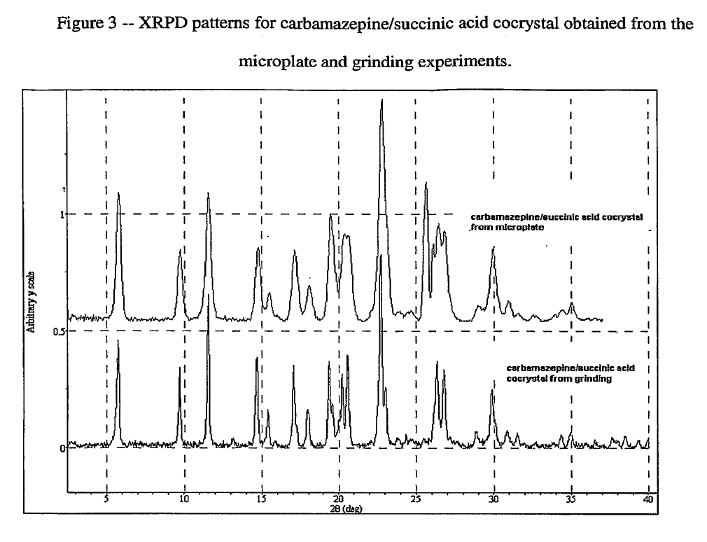

23.5 mg of carbamazepine, 11.6 mg succinic acid, and 20 microlitres of acetone was placed in an agate milling chamber and milled for 20 minutes on a Retch MM200 mixer mill. The material was recovered and characterized by x-ray powder diffraction which showed that the cocrystal of example 1 had formed. FIG. 3 shows x-ray powder diffraction data collected on the cocrystal prepared by the process of example 1 and that of example 3.

### Example 4

### Nabumetone/Glyclolic Acid/Acetone Solid Paste and Ultrasound

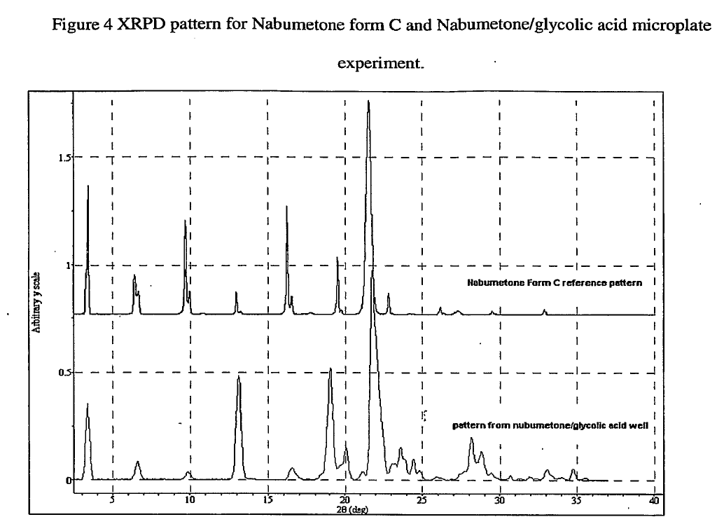

Approximately 3 mg of nabumetone and 1 mg of glycolic acid together with 100 microlitres of acetone were combined to form a solid paste and were placed in three wells of a 96-well microplate. The remaining 93 wells each contained 3 mg of nabumetone together with an acid other than glycolic acid. The 96-well microplate was placed in a SonicMan™ (MatriCal Inc., Spokane, Wash.) sonication device where the microplate was sealed with an interchangeable disposable sonic lid containing 96 individual sonic pins, one for each well of the well plate. Each pin was in contact with the sample in the respective well. The SonicMan™ device was then used to deliver sonic energy to the sample. The microplate was subjected to 2 seconds of ultrasound at 20 kHz. After a pause of 20 seconds, the microplate was again subjected to 2 seconds of ultrasound at 20 kHz. This cycle was repeated until five two-second bursts of 20 kHz ultrasound had been delivered to the microplate. Any solvent remaining in the microplate was allowed to evaporate at room temperature. The well containing nabumetone and glycolic acid gave an XRPD pattern of form C nabumetone (FIG. 4). That pattern also shows evidence of glycolic acid.

### Example 5

### Nabumetone Solution and Ultrasound

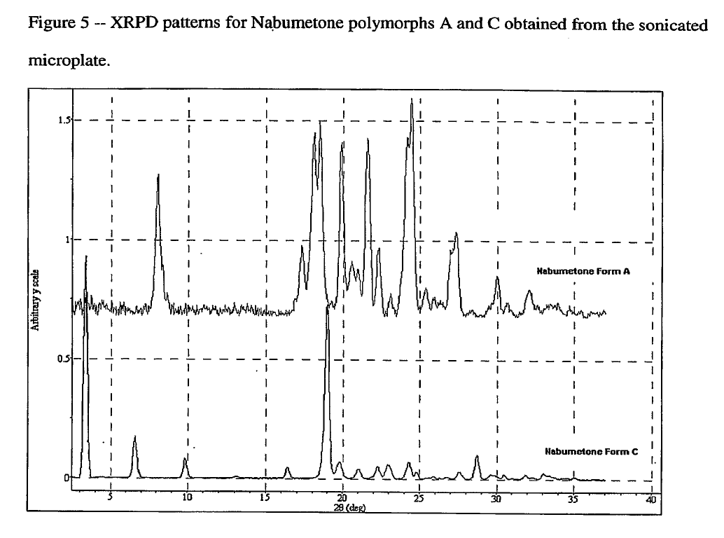

Approximately 0.1 g of Nabumetone was dissolved in 5 mL of each of the following solvents: Acetone, acetonitrile, dioxane and ethyl acetate. Each solvent solution was prepared multiple times. An aliquot of 100 microlitres of each these solutions was placed into different wells of a 96-well microplate. The 96-well microplate was placed in a SonicMan™ (MatriCal Inc., Spokane, Wash.) sonication device where the microplate was sealed with an interchangeable disposable sonic lid containing 96 individual sonic pins, one for each well of the well plate. Each pin was in contact with the sample in the respective well. The SonicMan™ device was then used to deliver sonic energy to the sample. The microplate was subjected to 2 seconds of ultrasound at 20 kHz. After a pause of 20 seconds, the microplate was again subjected to 2 seconds of ultrasound at 20 kHz. This cycle was repeated until ten two-second bursts of 20 kHz ultrasound had been delivered to the microplate. Any solvent remaining in the microplate was allowed to evaporate at room temperature. FIG. 5 shows the XRPD patterns for Nabumetone polymorphs A and C obtained from the sonicated microplate.

### Example 6

### Fluoxetine HCl/Benzoic Acid/Acetonitrile Solid Paste and Ultrasound

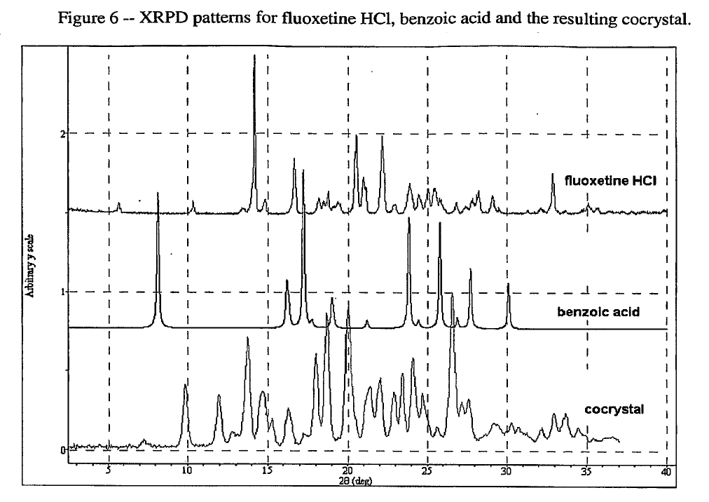

Approximately Fluoxetine HCl 3 mg of and 1 mg of benzoic acid together with 30 microlitres of acetonitrile were combined to form a solid paste and were placed in three wells of a 96-well microplate. The remaining 93 wells each contained 3 mg of Fluoxetine HCl together with an acid other than benzoic acid. The 96-well microplate was placed in a SonicMan™ (MatriCal Inc., Spokane, Wash.) sonication device where the microplate was sealed with an interchangeable disposable sonic lid containing 96 individual sonic pins, one for each well of the well plate. Each pin was in contact with the sample in the respective well. The SonicMan™ device was then used to deliver sonic energy to the sample. The microplate was subjected to 2 seconds of ultrasound at 20 kHz. After a pause of 50 seconds, the microplate was again subjected to 2 seconds of ultrasound at 20 kHz. This cycle was repeated until twenty two-second bursts of 20 kHz ultrasound had been delivered to the microplate. Any solvent remaining in the microplate was allowed to evaporate at room temperature. FIG. 6 shows the XRPD patterns for Fluoxetine HCl, benzoic acid acid, and the resulting cocrystal.

1. A method of screening for a solid form comprising sonicating a solid paste to provide a sonicated paste and analyzing the sonicated paste for the presence of a solid form.

2. The method of claim 1 wherein the solid paste comprises at least one active agent and a suitable liquid.

3. The method of claim 2 wherein the at least one active agent is an active pharmaceutical ingredient.

4. The method of claim 2 wherein solid paste further comprises at least one guest.

5. The method of claim 2 wherein the at least one active agent is an active pharmaceutical ingredient.

6. The method of claim 1, wherein the sonicated paste is analyzed by an analytical technique selected from x-ray powder diffraction, solid-state NMR, Raman spectroscopy, and infrared spectroscopy.

7. The method of claim 5 wherein the sonicated paste is analyzed by an analytical technique selected from x-ray powder diffraction, solid-state NMR, Raman spectroscopy, and infrared spectroscopy.

8. The method of claim 6 wherein the analytical technique is x-ray powder diffraction.

9. The method of claim 7 wherein the analytical technique is x-ray powder diffraction.

10. The method of claim 5 wherein the suitable liquid is selected from acetone, acetonitrile, dichloromethane, diethyl ether, diisopropyl ether, dioxane, dimethylformamide, dimethyl sulfoxide, ethanol, ethyl acetate, heptane, hexanes, propan-2-ol, methanol, tetrahydrofuran, toluene, and water.

11. The method of claim 5 wherein the suitable liquid is an organic solvent.

12. The method of claim 4 wherein the sonicated paste contains a cocrystal.

13. The method of claim 2 wherein the sonicated paste contains a polymorph.

14. The method of claim 8 wherein the sonicated paste contains a cocrystal.

15. A method of preparing a solid form comprising sonicating a solid paste to provide a sonicated paste.

16. The method of claim 15 wherein the solid form is a cocrystal.

17. The method of claim 15 wherein the solid form is a polymorph.

18. The method of claim 15 wherein the solid form is selected from allotropes, solvates, hydrates, amorphous compounds, mesophases, liquid crystals, and salts.

19. The method of claim 15 wherein the solid form is a salt.

20. The method of claim 1 wherein the solid form is a salt.
